(19) United States
(12) Patent Application Publication
(10) Pub. No.: US 2024/0317019 A1
(43) Pub. Date: Sep. 26, 2024

(54) AIR OUTLET APPARATUS

(71) Applicants: NIHON PLAST CO., LTD., Fujinomiya-shi (JP); HONDA MOTOR CO.,LTD., Tokyo (JP)

(72) Inventors: Shinya Endo, Shizuoka (JP); Takahito Shiotsuki, Shizuoka (JP); Yu Nakashima, Tokyo (JP)

(21) Appl. No.: 18/599,261

(22) Filed: Mar. 8, 2024

(30) Foreign Application Priority Data
Mar. 22, 2023 (JP) 2023-044967

(51) Int. Cl. B60H 1/00

(52) U.S. Cl. CPC B60H 1/00857

(57) ABSTRACT

Air outlet apparatus has case body that defines ventilation path inside case body and forms an air outlet, shielding body that is rotatably arranged in ventilation path in case body and can open and close ventilation path in accordance with rotation, operation section rotatable in a direction different from a rotation direction of shielding body, and link mechanism that has a plurality of link members that operate differently from each other and causes shielding body to interlock with an operation of operation section. Link mechanism is arranged outside ventilation path, and converts an operation of one of the link members into an operation of another link member, thereby interlocking and rotating operation section and shielding body, which have different rotation axes.

### CROSS REFERENCE TO RELATED APPLICATIONS

This application is entitled to and claims the benefit of Japanese Patent Application No. 2023-044967 filed on Mar. 22, 2023, the disclosure of which including the specification, drawings and abstract is incorporated herein by reference in its entirety.

### TECHNICAL FIELD

The present invention relates to an air outlet apparatus including a shielding body that can open and close a ventilation path according to rotation.

### BACKGROUND ART

Conventionally, in air conditioners used in vehicles such as automobiles, there is an air outlet apparatus arranged at an air outlet. The air outlet apparatus is installed in various parts of a vehicle, such as an instrument panel or a center console section, and contribute to improving comfort performance through heating and cooling.

In such an air outlet apparatus, a wind direction adjustment apparatus is known, which includes a front fin located at the air outlet, a rear fin having a rotation axis orthogonal to the front fin, and a damper apparatus located at the rear of the rear fin and having an rotation axis orthogonal to each fin, in which when an operating knob provided in the front fin is rotated around the axis, a rotational force is transmitted to a gear and the damper apparatus rotates, and thus, the ventilation path is opened or closed (for example, see PTL 1). With this configuration, three members, that is, the front fin, the rear fin, and the damper apparatus, can be operated with a single operating knob, and thus, it is possible to achieve compactness (thinness) while ensuring an opening area of the air outlet.

### CITATION LIST

### Patent Literature

PTL 1

Japanese Patent Application Laid-Open No. 2017-159876 (Pages 8 to 14 and FIGS. 5 to 12)

### SUMMARY OF INVENTION

### Technical Problem

However, in the case of the above-mentioned air outlet apparatus, since the operating knob provided on the front fin is used, the operating knob is located at the air outlet due to the layout. Therefore, there is a limit to how small the air outlet can be made so that the operating knob does not obstruct air blowing from the air outlet.

The present invention has been made in view of these points, and an object of the present invention is to provide an air outlet apparatus that can be made compact and that can improve a degree of freedom in layout.

### Solution to Problem

According to a first aspect, there is provided an air outlet apparatus including: a case body that defines a ventilation path inside the case body and forms an air outlet; a shielding body that is rotatably arranged in the ventilation path in the case body and can open and close the ventilation path in accordance with rotation; an operation section rotatable in a direction different from a rotation direction of the shielding body; and a link mechanism that has a plurality of link members that operate differently from each other and causes the shielding body to interlock with an operation of the operation section, in which the link mechanism is disposed outside the ventilation path, and converts an operation of one of the link members into an operation of another link member, thereby interlocking and rotating the operation section and the shielding body, which have different rotation axes.

In the air outlet apparatus according to a second aspect, in the air outlet apparatus according to the first aspect, the link mechanism includes a first link member connected to an operation section side and a second link member connected to a shielding body side, the first link member operates to rotate in an arc shape as the operation section rotates, and the second link member slides in a direction intersecting the rotation axis of the shielding body as the first link member operates.

### Advantageous Effects of Invention

According to the air outlet apparatus according to the first aspect, there is no need to arrange the operation section at the air outlet or set the rotation axis of the shielding body on the rotation axis of the operation section, and it is possible to achieve both compactness and improvement of a degree of freedom in layout.

According to the air outlet apparatus according to the second aspect, in addition to the effects of the air outlet apparatus according to the first aspect, it is possible to simply configure the link mechanism which interlocks the first link member and the second link member and rotates the shielding body as the operation section rotates.

### BRIEF DESCRIPTION OF DRAWINGS

FIG. 1A is a side view that illustrates an air outlet apparatus according to a first embodiment of the present invention and illustrates a state in which a shielding body does not block a ventilation path;

FIG. 1B is a side view that illustrates the air outlet apparatus according to the first embodiment of the present invention and illustrates a state in which the shielding body blocks the ventilation path;

FIG. 2 is a perspective view illustrating the air outlet apparatus from the rear;

FIG. 3 is an exploded perspective view of the air outlet apparatus;

FIG. 4 is a perspective view of the air outlet apparatus;

FIG. 5 is a perspective view illustrating an air outlet apparatus according to a second embodiment of the present invention from the rear; and

FIG. 6 is a side view of the air outlet apparatus.

### DESCRIPTION OF EMBODIMENTS

Hereinafter, a first embodiment of the present invention will be described with reference to the drawings.

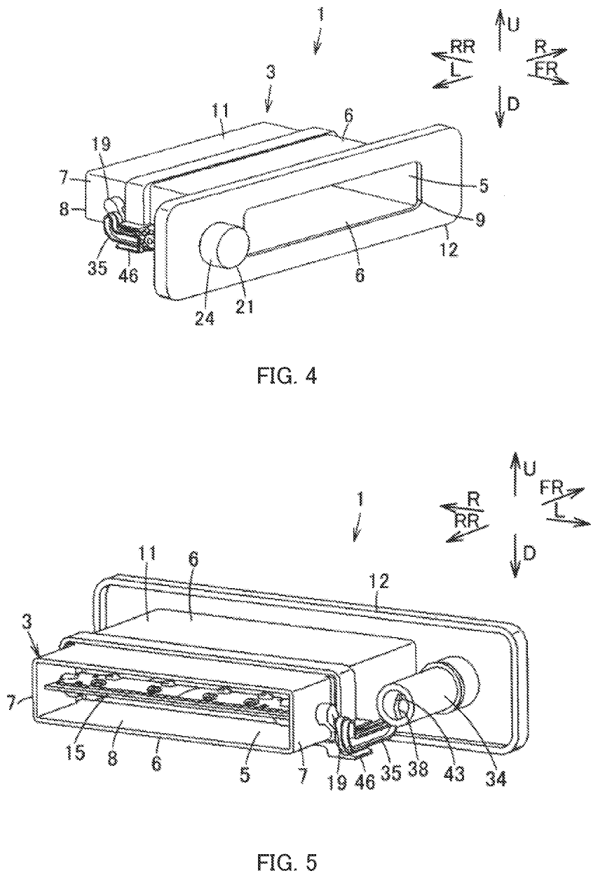

In FIGS. 3 and 4, a reference sign 1 is an air outlet apparatus. Air outlet apparatus 1 is connected to an air conditioner and blows out conditioned air. Hereinafter, for more clear description, in air outlet apparatus 1, a leeward side from which wind blows will be defined as a front side, a front surface side, or a near side. A side opposite thereto, that is, a windward side which receives the wind will be defined as a rear side, a back side, or a far side. In this manner, a both side direction or a width direction which is a right-left direction when viewed from the front side, and an up-down direction will be defined. In the present embodiment, air outlet apparatus 1 is applied to an air conditioner for a vehicle such as an automobile. Air outlet apparatus 1 may be arranged at any desired position. In the drawings, an arrow FR side will be defined as the front side, an arrow RR side will be defined the rear side, an arrow L side will be defined as a left side, an arrow R side will be defined as a right side, an arrow U side will be defined as an upper side, and an arrow D side will be defined as a lower side. These directions are illustrated as an example only, and may be appropriately changed depending on an installation position and an installation direction of air outlet apparatus 1.

Air outlet apparatus 1 includes case body 3. Case body 3 is also called a duct. Case body 3 is formed in a tubular shape. In the present embodiment, case body 3 is formed in a tubular shape in a front-rear direction. In the illustrated example, case body 3 is formed in a rectangular tubular shape. Ventilation path 5 is internally surrounded by case body 3. A direction parallel to a central axis of case body 3 is a ventilation direction of ventilation path 5. In the present embodiment, the ventilation direction of ventilation path 5 is the front-rear direction, and ventilation is performed from the rear side to the front side. That is, in ventilation path 5, the rear side is an upstream side in the ventilation direction, and the front side is a downstream side in the ventilation direction.

Case body 3 has a predetermined length in the ventilation direction of ventilation path 5. In the present embodiment, case body 3 is flat in the up-down direction, and is formed in a longitudinal shape in the right-left direction, that is, in a horizontally long shape. Therefore, air outlet apparatus 1 is formed in a horizontally thin shape. Case body 3 integrally has a central portion of ventilation path 5, that is, pair of end wall portions 6 facing each other across the central axis, and pair of side wall portions 7 coupling pair of end wall portions 6. Pair of end wall portions 6 face each other in the up-down direction, and pair of side wall portions 7 face each other in the right-left direction. Receiving port 8 for receiving air, that is, conditioned air into ventilation path 5, is surrounded by rear end portions of pair of end wall portions 6 and 6 and pair of side wall portions 7 and 7. Air outlet 9 for discharging the conditioned air from ventilation path 5 is surrounded by front end portions of pair of end wall portions 6 and 6 and pair of side wall portions 7 and 7. That is, the rear end portion of case body 3 serves as receiving port 8 for receiving the conditioned air into ventilation path 5, and the front end portion of case body 3 serves as air outlet 9 for discharging the conditioned air from ventilation path 5. Ventilation path 5 allowing communication is formed between receiving port 8 and air outlet 9. The conditioned air passes from receiving port 8 to air outlet 9. Receiving port 8 and air outlet 9 respectively have the horizontally long shape.

Case body 3 may be integrally formed, or may be formed by combining a plurality of members. In the present embodiment, case body 3 has case main body portion 11 and finisher 12 which is a design member. Case main body portion 11 is a main body portion forming an upstream side majority of case body 3. Case main body portion 11 is formed in a rectangular tubular shape. Finisher 12 is attached to a front end, that is, a downstream end of case main body portion 11. Finisher 12 is also called a panel, and forms a portion of the design of the vehicle interior at an installation position of air outlet apparatus 1. Finisher 12 is formed in a rectangular frame shape surrounding air outlet 9. In the present embodiment, finisher 12 is wider than case main body portion 11 in the right-left direction, that is, finisher 12 is formed wider than case main body portion 11.

Shielding body 15 is arranged inside case body 3, that is, in ventilation path 5. Shielding body 15 is also called a valve or the like. Shielding body 15 is a shut valve that rotates with respect to case body 3 to open and close ventilation path 5 in accordance with the rotation. Shielding body 15 is formed in a rectangular plate shape. Shielding body 15 has an outer shape larger than the cross-sectional shape of ventilation path 5. In the present embodiment, shielding body 15 is rotatable in the up-down direction and has a larger cross-sectional area in the up-down direction than ventilation path 5. Moreover, shielding body 15 is arranged in ventilation path 5 near receiving port 8 of case body 3, that is, on the upstream end side.

Shielding body 15 has shielding body rotating section 16. Shielding body rotating section 16 is rotatably held by shielding body rotation receiving section 17 formed in case body 3 (case main body portion 11). In the present embodiment, shielding body rotation receiving section 17 is formed on side wall portion 7. For example, one of shielding body rotating section 16 and shielding body rotation receiving section 17 is a shaft portion, and the other is a hole portion or a recessed section. In the present embodiment, shielding body rotating section 16 is the shaft portion, and shielding body rotation receiving section 17 is the hole portion having a round hole shape or a recessed section. In the illustrated example, one shielding body rotating section 16 is a shaft portion that is integral with shielding body 15, and other shielding body rotating section 16 is coaxial with one shielding body rotating section 16, shaft member 19 is connected to attachment section 18 integral with shielding body 15, and thus, other shielding body rotating section 16 is configured as a shaft portion. Further, shielding body rotation receiving section 17 is formed on side wall portion 7 of case body 3. In the present embodiment, shielding body rotation receiving section 17 is located at the center of side wall portion 7 in the up-down direction.

Shaft member 19 is also called a pin, and is integrally connected to attachment section 18 in a rotationally prevented manner. For example, attachment section 18 and shaft member 19 are integrally fixed by connecting attachment section connecting section 18a formed in attachment section 18 and shaft member connecting section 19a formed in shaft member 19 to each other. One of attachment section connecting section 18a and shaft member connecting section 19a is prismatic, and the other is a square hole portion or a recessed section. In the illustrated example, attachment section connecting section 18a is a square hole portion, and shaft member connecting section 19a is a prismatic portion. Then, shaft member connecting section 19a is inserted into shielding body rotation receiving section 17 from the outside of case body 3, inserted and fitted into attachment section connecting section 18a of attachment section 18 of shielding body 15 located within ventilation path 5, and connected to attachment section connecting section 18a. A portion of shaft member 19 is rotatably held by shielding body rotation receiving section 17. Therefore, attachment section 18 is located inside case body 3 (ventilation path 5) with one side wall portion 7 therebetween, and the remaining portion of shaft member 19 is located outside case body 3.

The rotation of shielding body 15 is interlocked with the operation of operation section 21. In the present embodiment, shielding body 15 is configured to rotate by transmitting the operation of operation section 21 to shaft member 19 via link mechanism 22. Operation section 21 and link mechanism 22 are located outside ventilation path 5.

Operation section 21 is also called an operating knob or an operation dial. Operation section 21 is provided to be rotatable. The rotation direction of operation section 21 is different from the rotation direction of shielding body 15. In the present embodiment, rotation axis C1 of operation section 21 is along the front-rear direction, and is a direction that intersects or orthogonal to rotation axis C2 of shielding body 15 along the right-left direction. Operation section 21 integrally includes knob section 24 that is exposed on the design side of air outlet apparatus 1, that is, the vehicle interior side and is directly operated by a user, and coupling section 25 that is connected to link mechanism 22.

For example, knob section 24 is formed in a columnar shape. Knob section 24 is arranged, for example, at extension section 12a of finisher 12 of case body 3 that extends laterally of air outlet 9. Knob section 24 is integrally connected to coupling section 25 in a state of being prevented from rotating. For example, knob section 24 and coupling section 25 are integrally fixed by connecting knob section connecting section 24a formed in knob section 24 and coupling section connecting section 25a formed in coupling section 25 to each other. One of knob section connecting section 24a and coupling section connecting section 25a is prismatic, and the other is a square hole portion or a recessed section. In the illustrated example, knob section connecting section 24a has a prismatic shape, and coupling section connecting section 25a has a square hole portion. Then, knob section connecting section 24a is inserted from the front of finisher 12 (extension section 12a) into insertion opening section 27 having a round hole shape formed in extension section 12a, inserted and fitted into coupling section connecting section 25a of coupling section 25 located on the back side of finisher 12 (extension section 12a), and connected to coupling section connecting section 25a, and thus, a part of the knob section 24 is rotatably held in insertion opening section 27. Therefore, with finisher 12 (extension section 12a) therebetween, the remaining portion of knob section 24 is located on the design side, that is, on the vehicle interior side, and coupling section 25 is located on the back side.

Insertion opening section 27 is formed to penetrate extension section 12a in the front-rear direction, which is the thickness direction. The center section of insertion opening section 27 is located at a position that substantially coincides with the center of air outlet 9 in the up-down direction, in the up-down direction. Therefore, rotation axis C1 of operation section 21, which coincides with the center section of insertion opening section 27, and rotation axis C2 of shielding body 15 are at the same or substantially the same position in the up-down direction. Operation section 21 (knob section 24) is within a width of a height of air outlet 9 in the up-down direction when viewed from the front side.

Coupling section 25 is formed into a columnar or cylindrical shape having a larger outer diameter than insertion opening section 27. Coupling section 25 includes arm section 30 that protrudes in the radial direction and link coupling section 31 that is coupled to link mechanism 22 is formed at a distal end portion of arm section 30. Link coupling section 31 is formed in a U-shape that opens rearward.

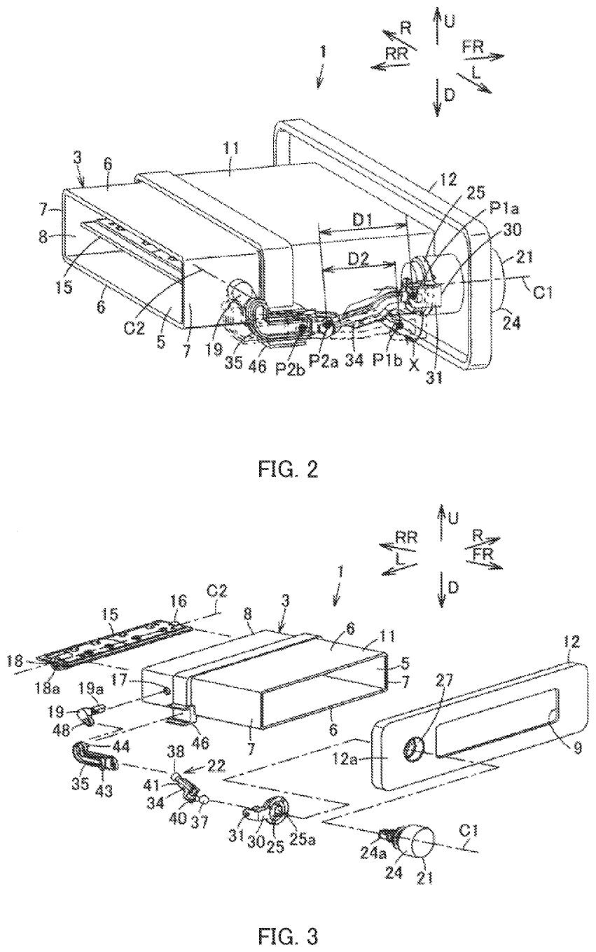

In the present embodiment, in operation section 21, a position where coupling section 25 is farthest from air outlet 9 when viewed from the front, that is, a position on a left side portion of operation section 21 is an open point position (position illustrated by a solid line in FIG. 2) P1a of shielding body 15, and a position where coupling section 25 is directly below rotation axis C1 of operation section 21 is set as a closed point position (position illustrated by a broken line in FIG. 2) P1b of shielding body 15.

Link mechanism 22 has a plurality of link members that operate differently from each other, and is configured as a conversion mechanism that converts the operation of one link member into the operation of another link member.

In the illustrated example, link mechanism 22 includes first link member 34 and second link member 35. For example, first link member 34 rotates, and second link member 35 slides. In other words, first link member 34 and second link member 35 are link members that operate differently from each other. In first link member 34, a front end portion which is one end portion is connected to operation section 21 side, in the present embodiment, link coupling section 31 of coupling section 25, and a rear end portion which is the other end portion is connected to a front end portion which is one end portion of second link member 35. Further, in second link member 35, a rear end portion which is the other end portion is connected to shielding body 15 side, in the present embodiment, shaft member 19.

First link member 34 is also called an operation section-side link member, a dial link, or the like. First link member 34 has operation section-side connection section 37 coupled to operation section 21 and link member-side connection section 38 coupled to second link member 35. First link member 34 is formed in an elongated shape in which second portion 41 connected to link member-side connection section 38 extends obliquely to first portion 40 connected to operation section-side connection section 37, and first portion 40 and second portion 41 are bent in a crank shape and are connected to each other. First link member 34 is arranged with the operation section-side connection section 37 and first portion 40 on the front side, and link member-side connection section 38 and second portion 41 on the rear side.

Operation section-side connection section 37 is located at a front end portion that is one end portion of first link member 34. In the present embodiment, operation section-side connection section 37 is formed in a spherical shape, and both sides thereof are rotatably held by link coupling section 31.

Further, link member-side connection section 38 is located at the rear end portion which is the other end portion of first link member 34. Link member-side connection section 38 is formed in a spherical shape, and both sides thereof are rotatably held by link coupling section 43 formed in second link member 35.

Second link member 35 is also called a shield-side link member, a valve link, or the like. Second link member 35 has link coupling section 43 coupled to first link member 34 and shielding body-side connection section 44 coupled to shaft member 19. Second link member 35 is formed in an elongated shape, is held by guide section 46, and along the longitudinal direction in the front-rear direction, second link member 35 is arranged slidably in the front-rear direction, that is, the direction intersect or orthogonal to rotation axis C2 of shielding body 15. Guide section 46 is also called a rail section or the like. In the present embodiment, guide section 46 is formed on a side portion of one side wall portion 7 of case body 3. Therefore, second link member 35 is located apart from rotation axis C1 of operation section 21 in the right-left direction, in the present embodiment, to the right. Furthermore, in the illustrated example, a rear end portion of second link member 35 is bent into an L-shape. In the present embodiment, the front-most position of second link member 35, that is, the position closest to operation section 21 in the front-rear direction is an open point position (position illustrated by the solid line in FIG. 2) P2a of shielding body 15, and the rear-most position thereof, that is, the position farthest from operation section 21 in the front-rear direction is a closed point position (position indicated by the broken line in FIG. 2) P2b of shielding body 15.

Link coupling section 43 is formed in a U-shape that opens toward the front, which is first link member 34 side. The opening direction of link coupling section 43 is a direction that is inclined toward operation section 21 side. In the present embodiment, link coupling section 43 is opened to the left front. At the position where second link member 35 is held by guide section 46, link coupling section 43 is located to be shifted to the side with respect to rotation axis C1 of operation section 21, that is, to the right in the present embodiment. That is, a connection point between first link member 34 and second link member 35 is configured to be apart from rotation axis C1 of operation section 21.

In the present embodiment, shielding body-side connection section 44 is formed in the shape of a pin that protrudes from second link member 35 toward side wall portion 7 side of case body 3. Shielding body-side connection section 44 is coupled to connection receiving section 48 formed in shaft member 19. Connection receiving section 48 is formed at a position protruding from shaft member 19 in the radial direction. That is, connection receiving section 48 is located away from rotation axis C2 of shielding body 15. Further, the connection point between second link member 35 and shielding body 15 is configured to be apart from rotation axis C1 of operation section 21.

In addition, ventilation path 5 may be provided with fins (louvers) that are movably held in case body 3 and are used to distribute air by operations such as rotation. The fins may have a single-stage configuration located facing air outlet 9, or may have a two-stage configuration located at air outlet 9 and an upstream side thereof. In the case of a two-stage configuration, it is preferable that the rotation axes of the upstream fins and the downstream fins are orthogonal to each other. The number of fins in each stage may be singular or plural. When provided with fins, air outlet apparatus 1 becomes a wind direction adjustment apparatus also called an air outlet, a ventilator, a register, or the like.

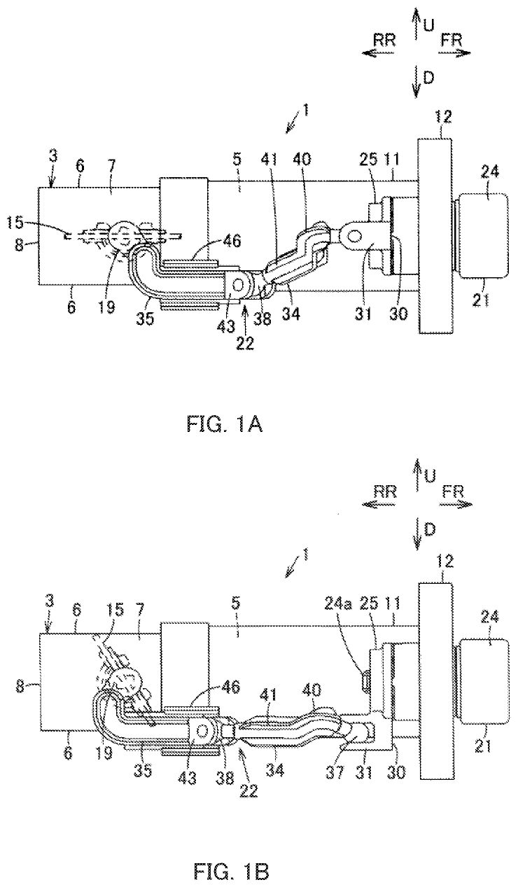

Air outlet apparatus 1 is arranged by coupling receiving port 8 to an air conditioner. When operation section 21 and second link member 35 are at open point positions P1a and P2a of shielding body 15, each main surface of shielding body 15 does not block ventilation path 5 along the ventilation direction, as illustrated in FIG. 1A. Therefore, the conditioned air from the air conditioner passes through ventilation path 5 from receiving port 8 and is blown out from air outlet 9 (FIG. 4). When air outlet apparatus 1 has fins, the direction of the conditioned air blown out from air outlet 9 (FIG. 4) changes depending on the operation of the fins.

Meanwhile, when blocking the blowing of conditioned air from air outlet 9 (FIG. 4), ventilation path 5 is blocked by shielding body 15. At this time, when the user pinches knob section 24 and rotates operation section 21 from open point position P1a of shielding body 15 to closed point position P1b as illustrated in FIG. 2, in the circumferential direction, for example, in the clockwise direction (illustrated by an arrow X) illustrated in FIG. 2, since operation section-side connection section 37 is coupled to coupling section 25, front end portion side of first link member 34 rotates in an arc shape centered on rotation axis C1 of operation section 21. At this time, since link coupling section 43 is not on rotation axis C1 of operation section 21 and is away from rotation axis C1, based on the position of link coupling section 43 when second link member 35 is at open point position P2a of shielding body 15, distance D2 in the front-rear direction to coupling section 25 in a state where operation section 21 is rotated to closed point position P1b of shielding body 15 is changed with respect to distance D1 in the front-rear direction to coupling section 25 when operation section 21 is at open point position P2a of shielding body 15. In the present embodiment, distance D2 is shorter than distance D1. Therefore, since operation section 21 and second link member 35 are coupled by first link member 34, distance D1 is maintained even when operation section 21 is rotated to closed point position P1b of shielding body 15. Therefore, due to the difference between distance DI and distance D2, second link member 35 slides rearward to reach closed point position P2b while being guided along guide section 46. That is, due to the rotation of first link member 34 of link mechanism 22 at operation section-side connection section 37, the rotation of link member-side connection section 38, and the guidance by guide section 46, the arc rotation of first link member 34 accompanying the rotation of operation section 21 is converted into a sliding motion of second link member 35. Therefore, when second link member 35 pushes connection receiving section 48 of shaft member 19 backward, shaft member 19 rotates, and as illustrated in FIG. 1B, shielding body 15 also rotates integrally with shaft member 19, and thus, shielding body 15 shields ventilation path 5. As a result, the conditioned air does not flow downstream of shielding body 15, and the conditioned air is prevented from being blown out from air outlet 9 (FIG. 4).

As described above, according to the first embodiment, since operation section 21 and shielding body 15 having different rotation axes are interlocked with each other and rotated using link mechanism 22 which is the conversion mechanism that is arranged outside ventilation path 5 and converts the operation of one link member into the operation of another link member, there is no need to arrange operation section 21 at air outlet 9 or set shielding body rotating section 16 of shielding body 15 on rotation axis C1 of operation section 21, and it is possible to achieve both compactness (thinness) and improvement of a degree of freedom in layout of operation section 21 or the like. Furthermore, by making air outlet apparatus 1 thinner, it is also possible to improve the appearance.

Furthermore, since link mechanism 22 is located outside ventilation path 5, link mechanism 22 and the operation thereof do not impede ventilation.

Link mechanism 22 includes first link member 34 connected to operation section 21 side and second link member 35 connected to shielding body 15 side, first link member 34 operates to rotate in an arc shape as operation section 21 rotates, and second link member 35 slides in a direction intersecting rotation axis C2 of shielding body 15 as first link member 34 operates. Therefore, it is possible to simply configure link mechanism 22 which interlocks first link member 34 and second link member 35 and rotates shielding body 15 as operation section 21 rotates.

In particular, since link mechanism 22 has a configuration that does not use gears, it is easy to assemble, and occurrence of rattling caused by backlash can be suppressed.

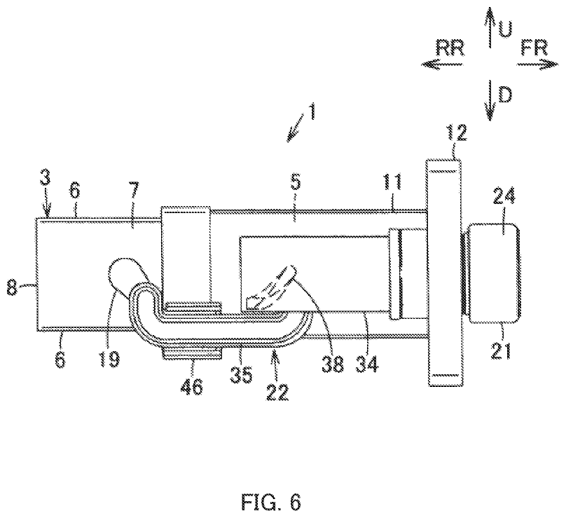

In addition, in the first embodiment, coupling section 25 rotates as operation section 21 rotates, and thus, the front end portion side of first link member 34 in which operation section-side connection section 37 is coupled to coupling section 25 is rotated in an arc shape. However, the present invention is not limited to this, as in a second embodiment illustrated in FIGS. 5 and 6, first link member 34 is formed into a cylindrical shape integral with operation section 21 (knob section 24), link member-side connection section 38 which is a spiral groove section is formed on an outer peripheral surface of first link member 34, a pin shape in which link member-side connection section 38 of second link member 35 is fitted into a cam groove is realized, and thus, first link member 34 may be configured to rotate in an arc shape as operation section 21 rotates. Even in this case, it is possible to achieve the same effects as in the first embodiment, such as being able to achieve both compactness (thinness) and improvement in the degree of freedom in the layout of operation section 21.

Furthermore, in each of the embodiments described above, rotation axis C1 of operation section 21 and rotation axis C2 of shielding body 15 may be located at different positions in the up-down direction.

In addition, a configuration in which air outlet apparatus 1 adopts the horizontal type has been described. However, air outlet apparatus 1 can also be configured in the same manner even when a vertical type whose longitudinal direction is the up-down direction is adopted. In that case, by rotating the arrangement of each of the above embodiments by 90° when viewed from the front, such as by rotating shielding body 15 in the right-left direction, the same effects as in each of the above embodiments can be achieved.

Furthermore, air outlet apparatus 1 is not limited to be used in an automobile, and may be used for any other desired purpose.

### INDUSTRIAL APPLICABILITY

For example, the present invention can be suitably used as an air outlet apparatus for air conditioning of an automobile.

### REFERENCE SIGNS LIST

1 Air outlet apparatus
3 Case body
5 Ventilation path
9 Air outlet
15 Shielding body
21 Operation section
22 Link mechanism
34 First link member
35 Second link member
C1, C2 Rotation axis

What is claimed is:

1. An air outlet apparatus comprising:
a case body that defines a ventilation path inside the case body and forms an air outlet;
a shielding body that is rotatably arranged in the ventilation path in the case body and can open and close the ventilation path in accordance with rotation;
an operation section rotatable in a direction different from a rotation direction of the shielding body; and
a link mechanism that has a plurality of link members that operate differently from each other and causes the shielding body to interlock with an operation of the operation section,
wherein the link mechanism is disposed outside the ventilation path, and converts an operation of one of the link members into an operation of another link member, thereby interlocking and rotating the operation section and the shielding body, which have different rotation axes.

2. The air outlet apparatus according to claim 1,
wherein the link mechanism includes
a first link member connected to an operation section side, and
a second link member connected to a shielding body side,
the first link member operates to rotate in an arc shape as the operation section rotates, and
the second link member slides in a direction intersecting the rotation axis of the shielding body as the first link member operates.
